(19) United States
(12) Patent Application Publication
(10) Pub. No.: US 2026/0227119 A1
(43) Pub. Date: Aug. 6, 2026

(54) REFRIGERATOR AND SERVER DEVICE CAPABLE OF DIAGNOSING STATE AND METHODS THEREOF

(71) Applicant: SAMSUNG ELECTRONICS CO., LTD., Suwon-si (KR)

(72) Inventors: Kyutae KIM, Suwon-si (KR); Jaehee BAEK, Suwon-si (KR); Sangyoul CHA, Suwon-si (KR)

(73) Assignee: SAMSUNG ELECTRONICS CO., LTD., Suwon-si (KR)

(21) Appl. No.: 19/637,621

(22) Filed: Apr. 2, 2026

Related U.S. Application Data
(63) Continuation of application No. PCT/KR2024/015582, filed on Oct. 15, 2024.

(30) Foreign Application Priority Data
Oct. 30, 2023 (KR) 10-2023-0147147

(51) Int. Cl. F25D 21/02; F25D 21/00; F25D 29/00

(52) U.S. Cl. CPC F25D 21/02; F25D 21/006; F25D 29/00; F25D 2400/36

(57) ABSTRACT

A server device includes: a communication unit configured to perform communication with at least one refrigerator; memory; and at least one processor, wherein the instructions, when executed by the at least one processor individually or collectively, cause the refrigerator to: receive state information of the at least one refrigerator through the communication unit and store the state information in the memory, calculate a frost formation index value for frost formation or a dew formation index value for dew formation of each of the at least one refrigerator based on the stored state information and store the index value in the memory, and diagnose a frost formation state or a dew formation state of the at least one refrigerator based on index values cumulatively stored during a predetermined period of time.

### CROSS-REFERENCE TO RELATED APPLICATION(S)

This application is a continuation of International Application No. PCT/KR 2024/015582, filed on Oct. 15, 2024, in the Korean Intellectual Property Receiving Office, which is based on and claims priority to Korean Patent Application No. 10-2023-0147147, filed on Oct. 30, 2023, in the Korean Intellectual Property Office, the disclosures of which are incorporated by reference herein in their entireties.

### BACKGROUND

### 1. Field

The disclosure relates to a refrigerator and server device capable of diagnosing a state and a method for diagnosing a state thereof.

### 2. Description of Related Art

Driven by the abundance of food and the advancement of electronics technology, refrigerators have become a necessity in most households. Refrigerators must constantly maintain a cold internal temperature to preserve the freshness of food. However, when a user frequently opens and closes a refrigerator door, hot and humid external air flows into the interior, which may cause frost or dew to form on the walls.

Although frost or dew formation is a natural phenomenon occurring due to the difference in temperature and humidity between external and internal air, it may be perceived as a product defect from a consumer's perspective. Accordingly, consumers may contact a service center to remove frost and dew or to resolve derivative problems. In the Related Art, even when an after-sales (A/S) representative receives a consumer complaint, there is a problem in that it is not easy to solve the issue because the state of the refrigerator cannot be accurately diagnosed from a remote location.

### SUMMARY

According to an aspect of the disclosure, a server device may include: a communication unit configured to perform communication with at least one refrigerator; memory storing instructions; and at least one processor, wherein the instructions, when executed by the at least one processor individually or collectively, cause the server device to: receive state information of the at least one refrigerator through the communication unit and store the state information in the memory, calculate a frost formation index value for frost formation or a dew formation index value for dew formation of each of the at least one refrigerator based on the stored state information and store the index value in the memory, and diagnose a frost formation state or a dew formation state of the at least one refrigerator based on index values cumulatively stored during a predetermined period of time.

The state information may include information regarding a number of times a defrosting operation or a dew removal operation is performed in the at least one refrigerator, external humidity information of the at least one refrigerator, and a cumulative door opening time information during which a door of the at least one refrigerator is opened for a preset unit time.

The instructions, when executed by the at least one processor individually or collectively, may cause the sever device to: calculate the frost formation index value according to f_ indexn=(OH×fDAT×A)+(fNDF×B)+(f_indexn−1 ×C), and calculate the dew formation index value according to r_indexn=(OH×rDAT×D)+(rNDF×E)+(r_indexn−1×F), where the f_ indexn is the frost formation index value, the OH is an external humidity value, the fDAT is a cumulative door opening time of a freezer compartment, the fNDF is the number of times the defrosting operation is performed, the f_indexn−1 is an immediately previous frost formation index value stored in the memory, the A, B, and C are preset weighting factors for diagnosing the frost formation state, the r_ indexn is the dew formation index value, the rDAT is a cumulative door opening time of a refrigerator compartment, the rNDF is the number of times the dew removal operation is performed, the r_ indexn−1 is an immediately previous dew formation index value stored in the memory, and the D, E, and F are preset weighting factors for diagnosing the dew formation state.

The instructions, when executed by the at least one processor individually or collectively, may cause the sever device to transmit a diagnosis code indicating an occurrence of frost formation or dew formation to a terminal device through the communication unit, based on an average value of the frost formation index values cumulatively stored for the predetermined period of time or an average value of the dew formation index values cumulatively stored for the predetermined period of time satisfying a preset condition.

The instructions, when executed by the at least one processor individually or collectively, may cause the sever device to generate a remote control signal to perform the defrosting operation or the dew removal operation and transmit the remote control signal to the at least one refrigerator through the communication unit, based on an average value of the frost formation index values cumulatively stored for the predetermined period of time or an average value of the dew formation index values cumulatively stored for the predetermined period of time satisfying a preset condition.

According to an aspect of the disclosure, a refrigerator may include: a plurality of sensors; memory storing instructions; and at least one processor, wherein the instructions, when executed by the at least one processor individually or collectively, may cause the refrigerator to: acquire state information of the refrigerator based on sensing values of the plurality of sensors, calculate a frost formation index value for frost formation or a dew formation index value for dew formation of the refrigerator based on the state information, store the index value in the memory, and diagnose a frost formation state or a dew formation state based on index values cumulatively stored during a predetermined period of time.

The instructions, when executed by the at least one processor individually or collectively, may cause the refrigerator to: acquire information regarding a cumulative door opening time during which a door of the refrigerator is opened for a preset unit time, based on a sensing value of a first sensor among the plurality of sensors, acquire external humidity information of the refrigerator, based on a sensing value of a second sensor among the plurality of sensors, perform a dew removal operation according to a sensing value of a third sensor among the plurality of sensors, and perform a defrosting operation according to a sensing value of a fourth sensor among the plurality of sensors, where the state information includes information regarding a number of times the defrosting operation or the dew removal operation is performed, the external humidity information, and the cumulative door opening time information.

The instructions, when executed by the at least one processor individually or collectively, may cause the refrigerator to: calculate the frost formation index value according to f_ indexn=(OH×fDAT×A)+(fNDF×B)+(f_indexn−1×C), and calculate the dew formation index value according to r_indexn=(OH×rDAT×D)+(rNDF×E)+(r_indexn−1×F), where the f_ indexn is the frost formation index value, the OH is an external humidity value, the fDAT is a cumulative door opening time of a freezer compartment, the fNDF is the number of times the defrosting operation is performed, the f_indexn−1 is an immediately previous frost formation index value stored in the memory, the A, B, and C are preset weighting factors for diagnosing the frost formation state, the r_ indexn is the dew formation index value, the rDAT is a cumulative door opening time of a refrigerator compartment, the rNDF is the number of times the dew removal operation is performed, the r_ indexn−1 is an immediately previous dew formation index value stored in the memory, and the D, E, and F are preset weighting factors for diagnosing the dew formation state.

The refrigerator may further include: a display, where the instructions, when executed by the at least one processor individually or collectively, may cause the refrigerator to control the display to display a diagnosis code indicating an occurrence of frost formation or dew formation, based on an average value of the frost formation index values cumulatively stored for the predetermined period of time or an average value of the dew formation index values cumulatively stored for the predetermined period of time being within a preset range.

The instructions, when executed by the at least one processor individually or collectively, may cause the refrigerator to perform the defrosting operation or the dew removal operation, based on an average value of the frost formation index values cumulatively stored for the predetermined period of time or an average value of the dew formation index values cumulatively stored for the predetermined period of time being within a preset range.

According to an aspect of the disclosure, a method for diagnosing a state of a server device may include: acquiring and storing state information of at least one refrigerator; calculating and storing a frost formation index value for frost formation or a dew formation index value for dew formation in the at least one refrigerator based on the stored state information; and diagnosing a degree of frost formation or a degree of dew formation based on index values cumulatively stored during a predetermined period of time.

The state information may include information regarding a number of times a defrosting operation or a dew removal operation is performed in the at least one refrigerator, external humidity information sensed by the at least one refrigerator, and cumulative door opening time information during which a door of the at least one refrigerator is opened for a preset unit time.

The calculating and storing the frost formation index value or the dew formation index value may include: calculating the frost formation index value according to f_ indexn=(OH×fDAT×A)+(fNDF×B)+(f_indexn−1×C); and calculating the dew formation index value according to r_indexn=(OH×rDAT×D)+(rNDF×E)+(r_indexn−1×F), where the f_ indexn is the frost formation index value, the OH is an external humidity value, the fDAT is a cumulative door opening time of a freezer compartment, the fNDF is the number of times the defrosting operation is performed, the f_indexn−1 is an immediately previous frost formation index value stored in the memory, the A, B, and C are preset weighting factors for diagnosing the degree of frost formation, the r_ indexn is the dew formation index value, the rDAT is a cumulative door opening time of a refrigerator compartment, the rNDF is the number of times the dew removal operation is performed, the r_ indexn−1 is an immediately previous dew formation index value stored in the memory, and the D, E, and F are preset weighting factors for diagnosing the degree of dew formation.

The method may further include: displaying a diagnosis code indicating an occurrence of frost formation or dew formation, based on an average value of the frost formation index values cumulatively stored for the predetermined period of time or an average value of the dew formation index values cumulatively stored for the predetermined period of time satisfying a preset condition.

The method may further include: generating a remote control signal to perform the defrosting operation or the dew removal operation and transmit the remote control signal to the at least one refrigerator, based on an average value of the frost formation index values cumulatively stored for the predetermined period of time or an average value of the dew formation index values cumulatively stored for the predetermined period of time satisfying a preset condition.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an operation of a server device according to at least one embodiment of the disclosure;

FIG. 2 is a block diagram illustrating a configuration of a server device according to at least one embodiment of the disclosure;

FIG. 3, FIG. 4, and FIG. 5 are graphs illustrating examples of state information according to at least one embodiment of the disclosure;

FIG. 6 is a diagram illustrating an operation of a server device transmitting diagnosis results to a display device according to at least one embodiment of the disclosure;

FIG. 7 is a block diagram illustrating a configuration of a refrigerator according to at least one embodiment of the disclosure;

FIG. 8 is a diagram illustrating an operation of a refrigerator according to at least one embodiment of the disclosure;

FIG. 9 is a block diagram illustrating a configuration of a mobile device capable of communicating with a refrigerator according to at least one embodiment of the disclosure;

FIG. 10 is a diagram illustrating a process of a server device transmitting a warning notification according to at least one embodiment of the disclosure; and

FIG. 11 and FIG. 12 are flowcharts illustrating various methods of diagnosing a state according to at least one embodiment of the disclosure.

### DETAILED DESCRIPTION

Hereinafter, embodiments are described in detail with reference to the accompanying drawings.

General terms may be used to describe embodiments of the disclosure in consideration of their functions in the disclosure. However, these terms may be changed depending on the intention of those skilled in the art or a judicial precedent, the emergence of a new technique, and the like. In addition, in a specific case, terms arbitrarily chosen by an applicant may exist. In this case, the meanings of such terms are mentioned in detail in corresponding descriptions of the disclosure. Therefore, the terms used in the disclosure may be defined on the basis of the meanings of the terms and the contents throughout the disclosure rather than simple names of the terms.

Hereinafter, various embodiments of the disclosure are described with reference to the accompanying drawings. However, it should be appreciated that the disclosure is not limited to a specific embodiment and all modifications, equivalents and/or alternatives thereof also belong to the scope of the disclosure. In describing the disclosure, if a detailed description for a related known function or construction is considered to unnecessarily divert the gist of the disclosure, such explanation has been omitted but would be understood by those skilled in the art.

Expressions “first,” “second,” or the like, used herein may qualify various components regardless of a sequence or importance of the components. These expressions are used only to distinguish one component from another component, and do not limit the corresponding components.

A term of a singular number may include its plural number unless explicitly indicated otherwise in the context. It is to be understood that a term “comprise”, “has”, “include,” “formed of,” and the like used in this application specify the existence of features, numerals, steps, operations, components, parts or combinations thereof, which is mentioned in the specification, and do not preclude the existence or addition of one or more other features, numerals, steps, operations, components, parts or combinations thereof.

Hereinafter, embodiments will be described in detail with reference to the accompanying drawings such that they may be easily practiced by those skilled in the art to which the disclosure pertains. The described embodiments may be modified in various different manners, all without departing from the spirit or scope of the disclosure. In the accompanying drawings, a portion irrelevant to description of the disclosure will be omitted for clarity. Like reference numerals refer to like elements throughout.

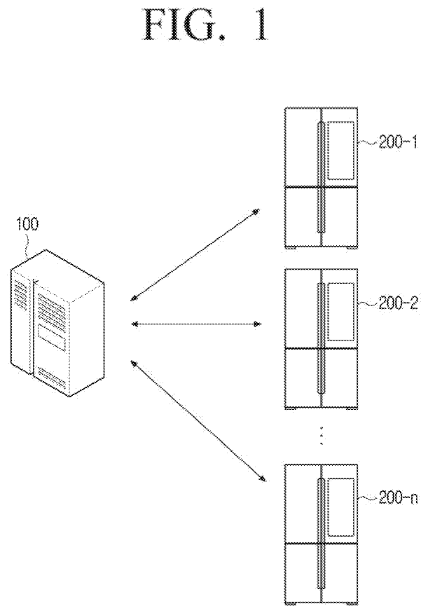

FIG. 1 is a diagram illustrating an operation of a server device according to at least one embodiment of the disclosure. The server device 100 may be configured to communicate with various electronic apparatuses. The server device 100 may be implemented as a cloud server or local server connected to various home appliances equipped with an Internet of Things (IoT) function, such as refrigerators, TVs, air-conditioners, electric rice cookers, air purifiers, vacuum cleaners, dehumidifiers, heaters, lighting, and washing machines, according to various wired or wireless communication protocols. In addition, the server device 100 may also be connected to various electronic apparatuses, such as PCs, laptops, tablet PCs, and smartphones.

FIG. 1 illustrates a server device 100 connected to a plurality of refrigerators 200-1 to 200-n. Each of the refrigerators 200-1 to 200-n may be used in various environments, such as homes, businesses, and government offices. Each of the refrigerators 200-1 to 200-n may transmit various state information to the server device 100 periodically or upon the occurrence of a specific event.

State information may include information indicating an operating state of each of the refrigerators 200-1 to 200-n or a surrounding environment. The operating state information may include various state information, such as the turn-on/off times of the refrigerators 200-1 to 200-n, set temperatures, the number of performed defrosting operations and durations thereof, the number of performed dew removal operations and durations thereof, the number of door openings, the cumulative door opening time, and an operating mode. The surrounding environment state information may include information regarding an ambient temperature, humidity, and a daily temperature range based on installation locations of the refrigerators 200-1 to 200-n.

The server device 100 may store the state information transmitted from each of the refrigerators 200-1 to 200-n in an internal memory or external storage medium thereof.

The server device 100 may diagnose the state of each of the refrigerators 200-1 to 200-n based on the stored state information and store diagnosis results. Diagnosis targets may be variously set, such as a normal operation state, a malfunction state, a frost occurrence state, and a dew formation state of each of the refrigerators 200-1 to 200-n.

For example, to diagnose frost or dew formation, the server device 100 may utilize, among the aforementioned state information, information on the number of times each of the refrigerators 200-1 to 200-n has performed a defrost or dew removal operation, external humidity information sensed by each of the refrigerators 200-1 to 200-n, and information on the cumulative door opening time during which each of the refrigerators 200-1 to 200-n is opened, among the state information described above.

According to an embodiment, the server device 100 may calculate and store an index value for frost or dew formation in each of the at least one refrigerator 200-1 to 200-nbased on the received state information. The server device 100 may accumulate and store the index values for a predetermined period of time. Based on the accumulated index values, the server device 100 may diagnose the frost or dew formation state of each of the refrigerators 200-1 to 200-n and store the diagnosis results. Based on an abnormality detected in the diagnosis results, the server device 100 may store a diagnosis code indicating the abnormality.

The server device 100 may utilize the diagnosis results in various manners.

For example, based on a user of each of the refrigerators 200-1 to 200-nidentifying that frost or dew has formed on their refrigerators and contacting an A/S center, an A/S representative may check state information and a diagnosis code for each user's refrigerator by referring to diagnosis result information stored in the server device 100. Accordingly, the service representative may analyze the user's usage patterns and the like and take more effective and accurate measures.

According to an embodiment, based on the diagnosis results indicating a high risk of frost or dew formation on the refrigerator or frost or dew having actually formed, the server device 100 may transmit a notification message to the refrigerator or terminal device of each user.

According to an embodiment, based on the diagnosis results indicating a high risk of frost or dew formation on the refrigerator or frost or dew having actually formed, the server device 100 may generate a remote control signal for performing a removal operation to remove the frost or dew and transmit the signal to the corresponding refrigerator. In this case, prior to transmitting the remote control signal, the server device 100 may transmit a message to the refrigerator or terminal device owned by the user asking whether remote control is permitted. Accordingly, based on the user permitting remote control, the server device 100 may transmit the aforementioned remote control signal. Conversely, based on the user not permitting remote control or no response for a predetermined period of time, the server device 100 may not transmit the remote control signal. In this case, the server device 100 may additionally store history information indicating the corresponding situation.

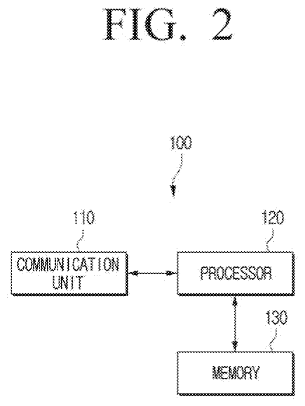

FIG. 2 is a block diagram illustrating a configuration of the server device 100 according to at least one embodiment of the disclosure.

According to FIG. 2, the server device 100 may include a communication unit 110, memory 130, and at least one processor 120.

The communication unit 110 may be configured to communicate with various external devices. In the environment shown in FIG. 1, the communication unit 110 may communicate with at least one refrigerator.

The communication unit 110 may transmit and receive various signals and data to and from the refrigerators 200-1 to 200-n or other external devices via various wired and wireless communication methods, such as Bluetooth, AP-based Wi-Fi (Wireless Local Area Network), Zigbee, wired/wireless LAN (Local Area Network), WAN (Wide Area Network), Ethernet, IEEE 1394, HDMI (High-Definition Multimedia Interface), USB (Universal Serial Bus), MHL (Mobile High-Definition Link), AES/EBU (Audio Engineering Society/European Broadcasting Union), optical, and coaxial.

The processor 120 may control the overall operation of the server device 100.

The processor 120 may include one or more of, or be defined by, a digital signal processor (DSP), a microprocessor, a central processing unit (CPU), a microcontroller unit (MCU), a micro-processing unit (MPU), a controller, an application processor (AP), a communication processor (CP), an ARM processor, or an artificial intelligence (AI) processor. In addition, the processor 120 may be implemented as a system on chip (SoC), a large scale integration (LSI), or a field programmable gate array (FPGA) with built-in processing algorithms. The processor 120 may perform various functions by executing computer executable instructions stored in the memory 130.

Based on the processor 120 receiving state information for at least one refrigerator through the communication unit 110, the processor 120 may store the received state information in the memory 130.

Based on the stored state information, the processor 120 may calculate an index value for frost or dew formation in each of the at least one refrigerator 200-1 to 200-n. The index value includes data that numerically expresses the degree of frost or dew formation or the likelihood of its occurrence. The index value may be referred to by various other terms, such as a feature value, an error value, a degree value, or a state value, but is referred to as an index value hereinafter.

The processor 120 may store the calculated index value in the memory 130. The processor 120 may calculate the index value frequently or periodically and accumulate and store the index value in the memory 130. The index values may be calculated individually, such as an index value related to frost and an index value related to dew formation, or may be calculated collectively for both phenomena. Hereinafter, a case in which that the index value for frost and the index value for dew formation are calculated separately is described.

In this situation, based on a specific event that occurs, the processor 120 may diagnose a frost or dew formation state of at least one refrigerator 200-1 to 200-n based on index values cumulatively stored over a predetermined period of time. Various event types may be set. For example, the processor 120 may perform a diagnosis based on the occurrence of an event in which a preset time period arrives, an event in which a diagnostic command is input via an input unit connected to the server device 100, an event in which a diagnostic request is received from an external device, or an event in which an A/S application is received for a specific refrigerator.

Frost refers to a phenomenon in which moisture-laden external air flows into a refrigerator and freezes upon colliding with the cold internal walls of the refrigerator. Dew formation refers to a phenomenon in which moisture contained in the external air condenses like dew inside the refrigerator. While frost and dew may occur in either the refrigerator compartment or freezer compartment, frost generally occurs primarily in the freezer compartment, and dew primarily occurs in the refrigerator compartment. Therefore, a case in which frost occurs in the freezer compartment and dew occurs in the refrigerator compartment will be described. To calculate an index value for frost, the processor 120 may perform a calculation based on Equation 1 below:
[Equation 1]
f_ indexₙ=(OH×fDAT×A)+(fNDF×B)+(f_indexₙ₋₁×C)

Equation 1 is an example of a calculation formula for calculating the index value for frost. In this disclosure, the index value for frost may refer to the magnitude of the possibility of frost formation and the area of frost formation and the thickness of the frost based on the formation of frost.

In Equation 1, f_ indexₙ denotes a frost formation index value representing the degree of frost measured at an n-th cycle, OH denotes external humidity, fDAT denotes the cumulative door opening time of a freezer compartment, fNDF denotes the number of defrosting operations performed for the freezer compartment, and f_indexn−1 denotes a frost formation index value measured and stored at an (n−1)-th cycle. A, B, and C represent preset weighting factors for frost diagnosis. Specifically, A denotes a weighting factor for the external humidity and cumulative door opening time, B denotes a weighting factor for the number of defrosting operations performed, and C denotes a weighting factor for cumulative non-opening. The weighting factor for the cumulative non-opening refers to a weighting factor for a period in which a door of the freezer compartment is not opened, excluding the cumulative door opening time and the time during which no defrosting operation of the freezer compartment occurs.

Each weighting factor represents a numerical value for a factor affecting the humidity inside the freezer.

A is a weighting factor for a phenomenon in which, based on the door of the freezer compartment being opened, external humidity flows into the freezer compartment, thereby increasing the internal humidity of the freezer compartment. B is a weighting factor according to an increase in humidity inside the freezer due to a sublimation of frost caused by a defrosting operation.

C is a weighting factor for a phenomenon in which, based on the door of the freezer being closed, internal air is cooled, a refrigerant in the evaporator circulates, a fan motor runs, and the air inside the freezer circulates internally. Accordingly, moisture-laden air adheres to the evaporator while passing therethrough, thereby decreasing the humidity inside the freezer.

A, B, and C may be set to optimal values through repeated experiments in which conditions, such as the cumulative door opening time, the number of defrosting operations performed, and external humidity are variously changed and combined. As an example, A, B, and C may be set to 0.02, 0.05, and 0.89, respectively

The defrosting operation refers to an operation of removing frost. A detailed description of the defrosting operation is provided below.

To calculate an index value for dew formation, the processor 120 may perform a calculation based on Equation 2.
[Equation 2]
r_indexₙ=(OH×rDAT×D}+(rNDF×E)+(r_indexₙ₋₁×F)

Equation 2 is an example of a calculation formula for calculating an index value for dew formation. In the disclosure, the index value for dew formation may refer to the magnitude of the possibility of dew formation, the area of dew formation in the event that dew is formed, the amount of dew, etc.

In Equation 2, r_ indexₙ denotes a dew formation index value representing the degree of dew formation measured at an n-th cycle, OH denotes the external humidity, rDAT denotes the cumulative door opening time of a refrigerator compartment, rNDF denotes the number of dew removal operations performed for the refrigerator compartment, and r_indexn−1 denotes a dew formation index value measured and stored at an (n−1)-th cycle. D, E, and F denote preset weighting factors for dew formation diagnosis. D denotes weighting factors for the external humidity and cumulative door opening time, E denotes a weighting factor for the number of dew removal operations performed, and F denotes a weighting factor for cumulative non-opening. Because descriptions of the respective weighting factors have been provided above, they will be omitted.

D, E, and F may be set to optimal values through repeated experiments in which conditions, such as the cumulative door opening time, the number of dew removal operations performed, external humidity etc., are variously changed and combined. As an example, D, E, and F may be set to 0.18, 5, and 0.025, respectively.

Based on the processor 120 initially calculating a frost formation index value or a dew formation index value (i.e., n=1), there cannot be a frost formation index value or a dew formation index value calculated in the immediately previous iteration (i.e., at (n−1)-th cycle). In this case, the processor 120 may use a default value (e.g., 1) stored in the memory 130 as the immediately previous frost formation index value or dew formation index value. According to an embodiment, the processor 120 may perform the calculation with the immediately previous frost formation index value or dew formation index value set to 0.

The processor 120 may periodically or intermittently calculate and accumulate frost formation index values or dew formation index values. For example, the processor 120 may newly calculate a frost formation index value or dew formation index value each time each refrigerator transmits state information.

The processor 120 may diagnose a frost or dew formation state of each refrigerator based on the cumulatively stored index values.

For example, based on the average value of the cumulatively stored index values satisfying a preset condition, the processor 120 may diagnose the state of the corresponding refrigerator as a good state or a dangerous state. The dangerous state may refer to a state in which frost or dew formation has occurred or is highly likely to occur.

Based on the state being diagnosed as the dangerous state, the processor 120 may calculate a diagnosis code indicating the occurrence of frost or dew formation and store the diagnosis code in the memory 130.

The preset condition may include a condition in which an average of the frost formation index values and an average of the dew formation index values accumulated during the immediately preceding X hours exceed a threshold index value (or a critical range) calculated when frost is formed and a threshold index value (or a critical range) calculated when dew is formed, respectively. The cumulative time may be set variously. For example, based on the cumulative time set to five days, the processor 120 may determine a good state based on the frost formation index value or the dew formation index value accumulated for five days being less than or equal to each threshold index value and may determine a dangerous state based on the frost formation index value or the dew formation index value accumulated for five days exceeding the threshold index value.

Based on the determination of the good state, the processor 120 may terminate the diagnosis without storing a separate diagnosis code. Conversely, based on the determination of the dangerous state, the processor 120 may generate a diagnosis code and store the diagnosis code in the memory 130. The good state refers to a state in which frost or dew has not formed or the possibility of occurrence is low, being equal to or less than a reference value. The good state may also be referred to as a normal or general state. The dangerous state refers to a state in which frost or dew has already formed or the possibility of occurrence exceeds the reference value. The dangerous state may also be referred to as a warning state, a non-general state, an abnormal state, a condensation state, etc.

A diagnosis code is a code indicating the occurrence of frost or dew formation. The diagnosis code may include a text message or a combination of letters, numbers, and symbols. The diagnosis code may also be referred to as an error code, error information, error message, or risk code. The diagnosis code may be individually generated for frost and dew formation or may be commonly generated for both frost formation and dew formation.

Although the case in which the condition for exceeding the threshold index value is set has been described above, the condition is not necessarily limited thereto. For example, even in a case in which an index value increases by a predetermined ratio or a predetermined value or more compared to previously measured index values, the processor 120 may determine that the condition is satisfied. The processor 120 may store the diagnosis result in the memory 130.

Meanwhile, in addition to diagnosing the occurrence or the possibility of occurrence of frost or dew formation, the processor 120 may also diagnose the cause of the occurrence.

According to an embodiment, the processor 120 may compare diagnosis results for one refrigerator to compare variables, i.e., state information, used in calculating index values for a good state and a dangerous state. For example, when the cumulative door opening time in the dangerous state is significantly greater than the cumulative door opening time in the good state, the processor 120 may infer that the cause is that the user opened the refrigerator door for a long period of time or opened and closed the refrigerator door too frequently.

According to an embodiment, the processor 120 may compare the state information and diagnosis results for a plurality of different refrigerators to infer the cause. For example, based on no significant difference between cumulative door opening time information and defrosting operation count information of a first refrigerator 200-1 and cumulative door opening time information and defrosting operation count information of a second refrigerator 200-2 but there is a significant difference in external humidity information and based on the first refrigerator 200-1 being diagnosed as a good state and the second refrigerator 200-2 being diagnosed as a dangerous state, the processor 120 may infer that the cause is the high external humidity of the second refrigerator 200-2. Based on the cause inference being possible, the processor 120 may also store a result of the cause inference in the memory 130. Similar to the diagnosis code, the result of the cause inference may include a combination of characters, numbers, and symbols or may be configured in the form of a text message.

The memory 130 is configured to store various software and data necessary for the operation of the server device 100. The memory 130 may be implemented as at least one of various types of memory, such as dynamic RAM (DRAM), static RAM (SRAM), synchronous dynamic RAM (SDRAM), one-time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD). While FIG. 2 illustrates only one memory 130, the disclosure is not limited thereto. The memory 130 may be implemented to include a plurality of memories, each storing different types of data or each storing data generated at different stages.

Also, while FIG. 2 illustrates the memory 130 as a separate component from the processor 120, the memory 130 may be formed integrally with the processor 120.

As described above, when data is received from connected refrigerators via the communication unit 110, the memory 130 may store the received information under the control of the processor 120. The memory 130 may also store information related to a user account of the corresponding refrigerator. For example, when the user purchases a refrigerator, he or she may access a website operated by a refrigerator manufacturer, sales company, or a third party and register a user account. To register the user account, the user may input various identification information, such as his or her name, age, address, phone number, email address, ID, and password, as well as product purchase information, such as a product name, product number, type, and purchase date of a product purchased by the user, through the website.

The processor 120 may create an account for the user by using the information input by the user and store information on the account in the memory 130. In this state, based on state information being transmitted from a user's refrigerator or terminal device, the processor 130 may receive the state information via the communication unit 110 and store the same in the memory 130 by matching the state information to the user's account. The memory 130 may accumulate and store state information each time the state information is transmitted. In addition, the memory 130 may store index values and diagnosis results (e.g., diagnosis codes, diagnosis timing, etc.) calculated by the processor 120 through the state information.

As described above, the state information received from refrigerators may include various information, such as an operating state of the refrigerator or a surrounding environment.

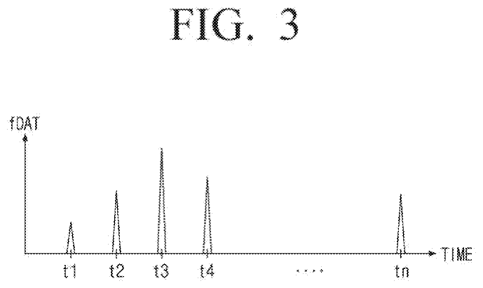

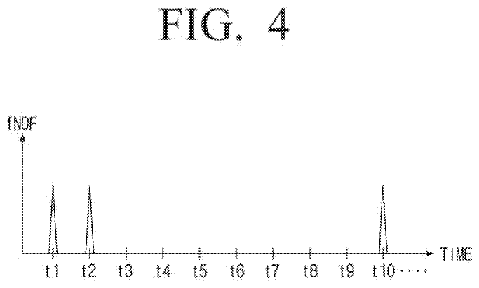

FIGS. 3 to 5 illustrate examples of state information according to at least one embodiment of the disclosure. FIGS. 3 to 5 are graphs representing time-based measurements.

FIG. 3 is a graph showing a cumulative door opening time (fDAT or rDAT) transmitted periodically. Each refrigerator may accumulate and store door opening times for a certain unit of time and then periodically transmit the information. For example, the cumulative door opening time received at time t2 in FIG. 3 may be time information collected by accumulating the door opening time during a period from time t1 to time t2. In a case in which a predetermined time (e.g., t′) is required for time accumulation and information transmission, information on the time accumulated during a unit time from time t1 to time t2−t′=t2′ may be transmitted. The cumulative door opening time transmitted at each time point may be expressed in various units, such as seconds, minutes, or hours. Each time the unit time of FIG. 3 elapses, the refrigerator may count the total cumulative door opening time during the corresponding unit time and then transmit a communication signal having a bit value corresponding to the counted time to the server device 100.

FIG. 4 is a graph showing information (fNDF or rNDF) regarding the number of times the defrost or dew removal operation is performed.

According to FIG. 4, when a refrigerator performs a defrosting or dew removal operation, a pulse signal may be output at each time the operation is performed. The processor 120 may count the number of pulse signals received over a predetermined period of time to identify the number of times the defrosting or dew removal operation was performed. FIG. 4 illustrates a state in which a total of three defrosting operations were performed during the time period from time t1 to time t10.

FIG. 5 is a graph showing external humidity information sensed by each refrigerator. According to FIG. 5, each refrigerator generates a communication signal including a bit value corresponding to the external humidity measured over a predetermined period of time (e.g., t1-t2) and transmits the communication signal to the server device 100. The processor 120 may receive the transmitted signal via the communication unit 110, detect humidity information from the signal, and then store the humidity information in the memory 130.

In FIGS. 3 to 5, units, such as t1 and t2, may be set to vary, such as hours, days, weeks, or months.

Meanwhile, according to an embodiment, some information, such as the cumulative door opening time, the number of times defrosting or dew removal operations have been performed, and external humidity information, may be omitted. That is, the occurrence of frost and dew is a condensation phenomenon of water vapor and is most significantly affected by the amount of humidity introduced into the installed space.

Therefore, according to another embodiment of the disclosure, the index value may be calculated solely using external humidity information and the cumulative door opening time.

According to another embodiment of the disclosure, the index value may be calculated solely using currently received information, without considering immediately previously stored frost formation index values or dew formation index values in the aforementioned Equation. In an embodiment, various state information other than those in FIGS. 3 to 5 may be further included. For example, the above-described index values may be calculated by further utilizing not only information on the number of times the defrosting operation or the dew removal operation is performed but also information on the cumulative time for which the operation is performed.

Manufacturers of refrigerators or server devices or other developers may determine state information to be used, measure the degree of occurrence of frost or dew formation, while changing weighting factors for each state information in various combinations, and then finally determine weighting factors that most closely match measurement results to acquire the Equations as described above. This operation may also be performed using an artificial intelligence model. In addition, the processor 120 may adjust the values of the constants (i.e., A, B, C, D, E, F) used in the Equations described above by updating the actual usage results of each refrigerator, either periodically or on a regular basis.

As described above, the diagnosis results of the server device 100 may be utilized in various manners.

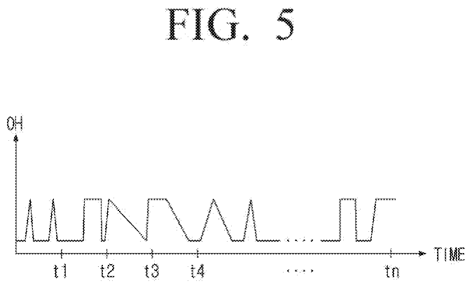

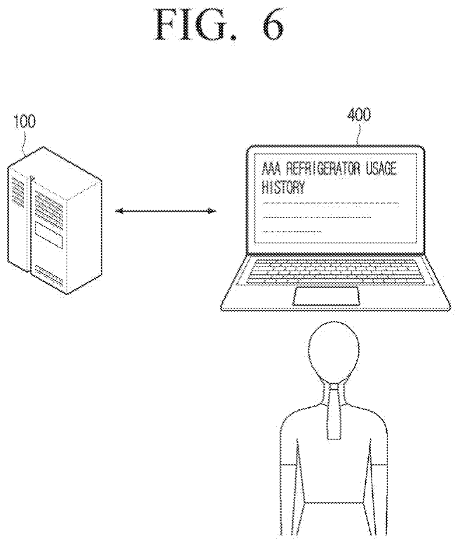

FIG. 6 is a diagram illustrating a server device transmitting diagnosis results to an external display device according to at least one embodiment of the disclosure.

According to FIG. 6, the server device 100 may store state information received from each of the refrigerators 200-1 to 200-n and the diagnosis result information acquired based on the state information. Based on the user with data access rights requesting data through his or her terminal device 400, the server device 100 may transmit the requested data to the terminal device 400.

In a case in which the user finds frost or dew in the refrigerator, the user may make an inquiry to an A/S center via telephone or online through methods, such as email or messenger. Based on the user inquiry being received, an A/S representative may read information on the refrigerator possessed by the user by using the terminal device 400. Based on data read request being received from the terminal device 400, the processor 120 controls the communication unit 110 to transmit state information, index values, diagnosis result information, and the like regarding the corresponding refrigerator to the terminal device 400. The diagnosis result information may be expressed in the form of a diagnosis code, but is not necessarily limited thereto, and may also be expressed in the form of a text message. The A/S representative may check the user's refrigerator usage records and diagnosis codes through the terminal device 400, making it possible to provide more effective services by performing a customized diagnosis for each user.

As an example, after checking the user's refrigerator usage pattern and the diagnosis code, the A/S representative may accurately and specifically explain the cause of frost or dew occurrence to the user. In addition, the A/S representative may provide instructions on measures to remove or prevent frost or dew. For instance, in a case in which the cumulative door opening time is long, the representative may recommend the user not to leave the door open for too long and in a case in which the ambient humidity is too high, the representative may recommend changing the environment surrounding the refrigerator.

As another example, the A/S representative may immediately remove frost or dew by remotely driving a fan or a heater within the corresponding refrigerator. In this case, the A/S representative may first confirm with the user via phone, email, or messenger whether the user wish to allow remote control of the refrigerator before proceeding.

In the above, embodiments in which the server device capable of communicating with each refrigerator diagnoses the state of each refrigerator have been described, but such diagnosis may also be performed autonomously by the refrigerator itself.

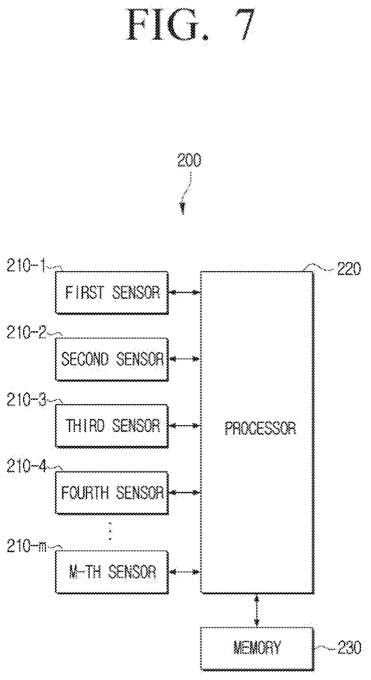

FIG. 7 is a block diagram illustrating a configuration of a refrigerator 200 according to at least one embodiment of the disclosure.

According to FIG. 7, the refrigerator 200 includes a plurality of sensors 210-1 to 210-m, a processor 220, and a memory 230.

The plurality of sensors 210-1 to 210-m are configured to acquire state information about the refrigerator.

Specifically, the plurality of sensors 210-1 to 210-m may include a first sensor 210-1 for sensing a door open/close state, a second sensor 210-2 for sensing external humidity, a third sensor 210-3 for sensing dew formation inside the refrigerator compartment, and a fourth sensor 210-4 for sensing frost formation inside the freezer compartment.

The processor 220 controls the overall operation of the refrigerator 200.

The memory 230 stores various programs, commands, data, etc. required for the operation of the refrigerator 200.

The processor 220 and the memory 230 may be implemented in various examples, as described above in the server device described above, and thus, redundant descriptions thereof will be omitted.

The processor 220 acquires state information of the refrigerator 200 based on sensing values from a plurality of sensors, calculates an index value for frost or dew formation on the refrigerator 200 based on the state information, and stores the index value in the memory 230.

The processor 220 may diagnose the frost or dew formation state based on the index values cumulatively stored over a predetermined period of time.

Specifically, the processor 220 may identify whether each door is opened or closed based on a sensing value from the first sensor 210-1. While FIG. 7 illustrates one first sensor 210-1, a plurality of first sensors 210-1 may be provided to correspond to the number of doors. For example, based on the refrigerator 200 including one refrigerator compartment and one freezer compartment, each of which is opened and closed by a single door, two first sensors 210-1 may be provided. The first sensor 210-1 may be provided on the door side or on a main body side with which the door makes contact.

The main body of the refrigerator 100 is a component that forms the overall exterior and interior space of the refrigerator. The main body may largely include an inner case, an outer case disposed outside the inner case, and an insulating material provided therebetween. The inner case is a component that forms a refrigerator compartment and a freezer compartment, respectively. The freezer compartment refers to a storage compartment in which a set temperature is set below the freezing point of an object, and the refrigerator compartment refers to a storage compartment in which the set temperature is set to a value exceeding the freezing point and lower than room temperature. Various items, such as food, medicine, and cosmetics, may be stored in the refrigerator compartment and the freezer compartment depending on the purpose of the refrigerator 200. Each of the refrigerator compartment and the freezer compartment may be opened and closed by at least one door. At least one magnet capable of engaging with the inner case of the main body may be included in an inner edge portion of each door. The first sensor 210-1 may output signals of different magnitudes depending on whether the door is in a closed state or an opened state.

Based on a signal of a first value being output from the first sensor 210-1, the processor 220 may identify the door as being closed, and based on a signal of a second value being output, the processor 220 may identify the door as being opened. Based on a signal of a second value being output from the first sensor 210-1, the processor 220 may drive a timer to count the door opening time. Based on a signal of the first value being output again, the processor 220 may store the counted time until that time in the memory 230.

The processor 220 may calculate the cumulative door opening time by adding up the counted times for each unit of time. As described above, a plurality of first sensors 210-1 may be provided depending on the number of doors, and the processor 220 may determine whether the storage compartment in which each door is installed is open based on the output values of the plurality of first sensors 210-1. For example, in the case of a French-type refrigerator with two doors that may open and close a single refrigerator compartment without an internal partition, the processor 220 may determine that the storage compartment is open even if only one of the two doors is open. In this structure, with both doors opened, more external humidity may enter the refrigerator than with only one door opened.

Therefore, according to another embodiment of the disclosure, in the French-type refrigerator, the processor 220 may distinguish between the time when both doors are open and the time when only one door is open and reflect them in the diagnosis. In this case, while fDAT or rDAT is described individually in the above-described Equations 1 or 2, in the present embodiment, fDAT or rDAT may each be set to two variables (e.g., rDAT1 and rDAT2). Here, rDAT1 may be the cumulative time for both doors to be opened, and rDAT2 may be the cumulative time for one door to be opened.

As described above, based on the sensing value of the first sensor 210-1, the processor 220 may acquire cumulative door opening time information during which each door of the refrigerator is opened for a preset unit time. The second sensor 210-2 is a humidity sensor for sensing an external humidity state. Although only one second sensor 210-2 is illustrated in FIG. 7, a plurality of second sensors 210-2 may be provided depending on the size, type, etc., of the refrigerator. The second sensor 210-2 may be disposed at various positions in the main body of the refrigerator 200.

Specifically, the second sensor 210-2 may be disposed on a front surface of the door of the refrigerator 200 or on a rear surface of the refrigerator 200. Alternatively, the second sensor 210-2 may be disposed on an upper side of the refrigerator 200. According to an example, a top table, which is detachable from the main body, may be provided on the upper side of the refrigerator 200, and the second sensor 210-2 may be disposed within the top table. Based on a sensing value from the second sensor 210-2, the processor 220 may acquire humidity information around the refrigerator 200, i.e., external humidity information.

Meanwhile, the external humidity information does not necessarily have to be acquired directly through the second sensor 210-2 installed in the refrigerator 200. For example, the processor 220 may also receive and utilize humidity information sensed by another device (e.g., an air-conditioner) located near the refrigerator 200.

Alternatively, the processor 220 may use humidity information received from an external server device that provides weather information for the area in which the refrigerator 200 is located.

The third sensor 210-3 is configured to sense dew formation within the refrigerator compartment, and the fourth sensor 210-4 is configured to sense frost formation within the freezer compartment.

The third sensor 210-3 and the fourth sensor 210-4 may each be configured in various manners. For example, the third sensor 210-3 and the fourth sensor 210-4 may each include an upper sensor that detects an upper temperature of a cooler that supplies cold air to the refrigerator compartment or freezer compartment and a lower sensor that detects a lower temperature of the cooler. The processor 220 may determine that frost or dew formation has occurred based on the temperature difference detected by the upper and lower sensors exceeding a threshold value. For example, based on the temperature difference between the upper and lower sensors of the cooler connected to the refrigerator compartment exceeding the first threshold, the processor 220 may predict that dew will be formed in the refrigerator compartment. Alternatively, based on the temperature difference between the upper and lower sensors of the cooler connected to the freezer compartment exceeding a second threshold, the processor 220 may predict that dew will be formed in the freezer compartment.

As another example, the third sensor 210-3 and the fourth sensor 210-4 may be implemented as a light-emitting element and a light-receiving element, respectively. The light-emitting element and the light-receiving element may be disposed to face each other based on a portion in which frost or dew is generally formed (i.e., the periphery of the cooler). Based on light emitted by the light-emitting element being normally received by the light-receiving element, the processor 220 determines that no dew or frost has been formed. Based on light being not received or the intensity of the received light being equal to or less than a reference value, the processor 220 may determine that dew or frost has been formed.

As another example, the third sensor 210-3 and the fourth sensor 210-4 may each be implemented as image sensors. The processor 220 may analyze captured images captured by the third sensor 210-3 and the fourth sensor 210-4 and identify the presence of frost or dew.

In addition, the third sensor 210-3 and the fourth sensor 210-4 may be implemented in various forms.

The processor 220 may perform a dew removal operation to remove dew from the refrigerator compartment based on a sensing value of the third sensor 210-3. In addition, the processor 220 may perform a defrosting operation to remove frost from the freezer compartment based on a sensing value of the fourth sensor 210-4.

When the processor 220 performs a dew removal operation or a defrosting operation, the processor 220 may accumulate and store the number of such operations in the memory 230. According to an embodiment, the processor 220 may store and manage cumulative time information for performing dew removal operations and cumulative time information for performing defrosting operations in the memory 230. For example, a cumulative fan driving time, a cumulative heater driving time, and the like may be stored in the memory 230.

As described above, the processor 220 may acquire various state information based on the sensing values of the plurality of sensors 210-1 to 210-m. Based on the acquired state information, the processor 220 may calculate an index value for frost or dew formation in the refrigerator. The specific equations and methods for calculating the index value may be implemented in almost the same manner as in the server device described above. Therefore, a redundant description thereof will be omitted.

Based on the average of the cumulatively stored index values satisfying a preset condition, the processor 220 calculates a diagnosis code indicating the occurrence of frost or dew formation and stores the diagnosis code in the memory 230. As described above, the preset condition may be a condition in which an average of the frost formation index values accumulated during the immediately preceding X hours exceeds a threshold index value or a threshold range calculated when actual frost is formed or a condition in which an average of the dew formation index values accumulated during the immediately preceding X hours exceeds a threshold index value or a threshold range calculated when actual dew is condensed; however, the present disclosure is not necessarily limited thereto, and various conditions may be set.

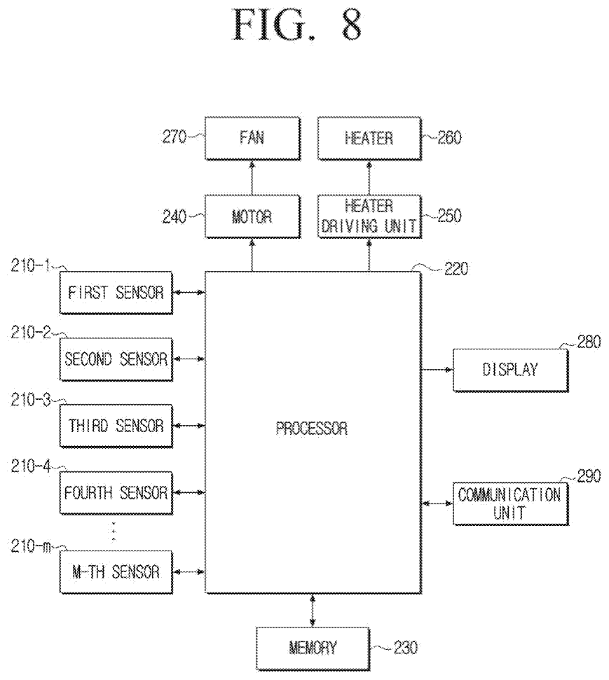

FIG. 8 is a diagram illustrating an example of a detailed configuration of the refrigerator 200 according to at least one embodiment of the disclosure.

According to FIG. 8, the refrigerator may include a display 280, a motor 240, a fan 270, a heater driving unit 250, a heater 260, a display 280, and a communication unit 290, as well as the plurality of sensors 210-1 to 210-m, the processor 220, and the memory 230 described above. Redundant descriptions of the same components of FIG. 8 as those described above with reference to FIG. 7 will be omitted.

The processor 220 may calculate an average value of the generated frost and dew formation index values. Based on the calculated average value satisfying a preset condition, the processor 220 controls the display 270 to display a diagnosis result indicating the occurrence of frost or dew formation.

The display 270 is formed on the outer surface of the refrigerator 200 and is configured to display various information under the control of the processor 220. The display 270 may be implemented as a display including a self-luminous element or as display including a non-luminous element and a backlight. For example, the display may be implemented in various forms, such as a liquid crystal display (LCD), organic light emitting diode (OLED), light emitting diode (LED), micro LED, mini LED, plasma display panel (PDP), quantum dot (QD) display, or quantum dot light-emitting diode (QLED). The display 270 may also include a driving circuit, a backlight unit, and the like, which may be implemented in forms, such as a-Si TFT, low temperature poly silicon (LTPS) TFT, or organic TFT (OTFT).

The display 270 may be implemented in a form attached to a door of the refrigerator 200, but is not limited thereto. For example, the display 270 may be embedded in the door of the refrigerator 200 and remain invisible during a normal operation, but may be revealed on the outer surface of the door only when turned on and emitting light.

Based on the diagnosis results being displayed on the display 270 under the control of the processor 220, the user may immediately recognize that frost or dew may be formed in the refrigerator.

According to another embodiment, the processor 220 may perform a defrosting or dew removal operation based on the average value of index values calculated over a predetermined period of time satisfying a preset condition. Defrosting is an operation of removing frost that has been formed. Defrosting may be performed in various manners. In an example, the processor 220 transmits a control signal for driving the heater 260 installed on one side of the cooler provided in the freezer compartment to the heater driving unit 250. The heater driving unit 250 drives the heater by applying current or voltage to the heater. Heat generated by the heater may melt frost around an evaporator in the cooler.

The dew removing operation is an operation of removing dew that has been formed inside the refrigerator. Dew is caused by the difference in humidity and temperature within the refrigerator. When moist air inside the refrigerator comes into contact with a cooled surface, moisture in the air is condensed to form dew. The dew removing operation may be performed in various manners. For example, the processor 220 transmits a control signal to the motor 240 to drive the motor 240. The motor 240 rotates the fan 270 connected thereto. The rotation of the fan 270 circulates the air inside the refrigerator compartment, thereby removing the dew.

The communication unit 290 is a component for communicating with the server device 100 or other external devices. The processor 220 may transmit and receive various signals and data to and from various external devices through the communication unit 290. A specific example of the communication unit 290 may also be similar to the communication unit of the server device described above, and thus, redundant descriptions will be omitted.

The processor 220 may transmit various information, such as state information of the refrigerator 200, index values calculated based on the state information, and diagnosis results based on the index values, to the server device 100 or other external devices via the communication unit 290. For example, based on an application for controlling the refrigerator 200 being installed on the user's smartphone, a processor of the smartphone may communicate with the processor 220 of the refrigerator 200 upon execution of the application. The processor 220 may also transmit the aforementioned information to the smartphone, so that the user may immediately monitor the state of the refrigerator through his/her smartphone.

FIG. 8 illustrates a case in which both the display 280 and the communication unit 290 are mounted on the refrigerator 200. However, at least some of them may be omitted.

Although FIGS. 7 and 8 illustrate that the refrigerator 200 independently calculates index values, identifies diagnosis results based on the index values, and displays the diagnosis results, or performs an operation according to the diagnosis results, the configuration of FIGS. 7 and 8 may also be used in an embodiment interworking with the server device 100. In this case, the processor 220 may transmit state information acquired based on sensing values from the plurality of sensors 210-1 to 210-m to the server device 100 or other terminal device via the communication unit 290.

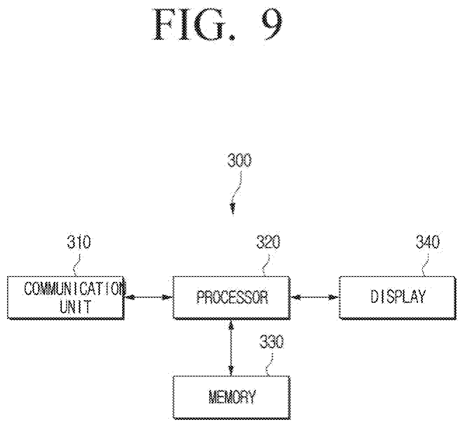

FIG. 9 is a block diagram illustrating a configuration of a terminal device capable of communicating with a refrigerator according to at least one embodiment of the disclosure; The terminal device may be implemented as various types of electronic apparatuses, such as a smartphone, PC, laptop PC, tablet PC, TV, wireless speaker, or kiosk.

According to FIG. 9, a terminal device 300 includes a communication unit 310, a processor 320, a display 340, and a memory 330. Specific examples of each component are almost the same as those described for other devices described above, so redundant descriptions will be omitted.

The communication unit 310 may communicate with various devices including the refrigerator 200 and the server device 100. While FIG. 1 illustrates that the refrigerator 200 directly transmits state information to the server device 100, in at least one embodiment, the state information of the refrigerator 200 may be first provided to the terminal device 300 via the communication unit 310. The processor 320 of the terminal device 300 may store the state information of the refrigerator 200 in the memory 330 and then transmit the state information to the server device 100 via the communication unit 310.

In addition, the communication unit 310 may also receive index values or other diagnosis results calculated by the server device 100. The processor 320 may control the display 340 to display state information, index values, diagnosis results, and the like. The display 340 may display a UI screen including the various information described above. The UI screen may display at least one menu selectable by the user. For example, an execution menu for performing a defrosting or dew removal operation, an adjustment menu for adjusting a set temperature of the refrigerator compartment or freezer compartment, etc. may be displayed. When the user selects one of the menus, the processor 320 controls the communication unit 310 to transmit a control signal corresponding to the selected menu to the refrigerator 200 or the server device 100. The processor 220 of the refrigerator 200 may perform an operation according to the control signal.

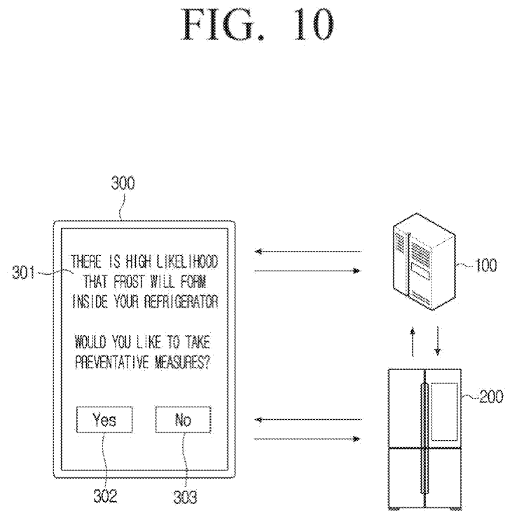

FIG. 10 illustrates an example of a UI screen displayed on the terminal device 300. According to FIG. 10, the processor 220 may control the display 340 to display a UI screen 301 based on information received from the server device 100. FIG. 10 illustrates a configuration of the UI screen 301 including a text message informing the user that there is a high possibility of frost formation in the refrigerator of the user and menus 302 and 303 related thereto. When the user selects a first menu 302, the processor 220 generates a control signal to perform a defrosting operation to prevent or remove frost and transmits the control signal to the refrigerator 200 or the server device 100 via the communication unit 310. Based on the user selecting the second menu 303, the processor 220 may remove the UI screen without performing any other operation. In this case, the processor 220 may store the user's selection history (i.e., the situation in which yes or no was selected) in the memory 330 along with a diagnosis code indicating a high possibility of occurrence of frost or dew formation.

The memory 330 may store an application for interworking with the refrigerator 200. The processor 320 executes the application and controls the display 340 to display the execution screen. The execution screen of the application may be the UI screen described above.

Meanwhile, in the above-described embodiments, it is described that the server device 100 or the refrigerator 200 calculates index values based on refrigerator state information and diagnoses the state. However, according to another embodiment of the disclosure, the processor 320 of the terminal device 300 may perform the operation. Based on acquiring the index value and the diagnosis result based on the index value, the processor 320 may transmit the acquired information to the refrigerator 200 or the server device 100. In this case, the processor 320 may generate a UI screen as illustrated in FIG. 10 and control the display 340 to display the UI screen. Based on a user command input by the user to perform a frosting operation or dew removal operation on the UI screen, the processor 320 generates a control signal to perform the operation and transmits the control signal to the refrigerator 200 via the communication unit 310.

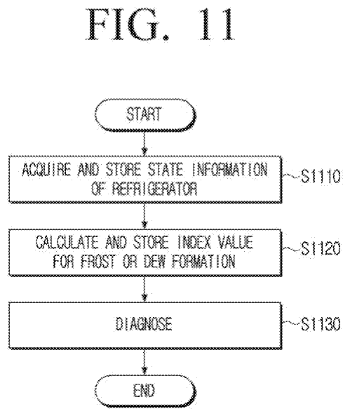

FIG. 11 is a flowchart illustrating a state diagnosis method according to at least one embodiment of the disclosure. According to various embodiments of the disclosure, the state diagnosis method of FIG. 11 may be performed by any of a server device, a refrigerator, and a terminal device. However, the following description will focus on the case in which the server device performs the diagnosis.

According to FIG. 11, the server device acquires and stores state information of a refrigerator (S1110). Based on the stored state information, the server device calculates and stores an index value for frost or dew formation in the refrigerator (S1120). The server device diagnoses the degree of frost or dew formation based on the index values cumulatively stored during a predetermined period of time (S1130). The specific index value calculation and diagnosis methods have been described in detail in the various embodiments described above, and therefore, a detailed description thereof will be omitted.

As described in FIGS. 3 to 5, state information may include various information, such as external humidity information sensed by the refrigerator, information on the cumulative door opening time during which a door of the refrigerator is opened for a preset unit time, and information on the number of times a defrosting operation or a dew removal operation is performed.

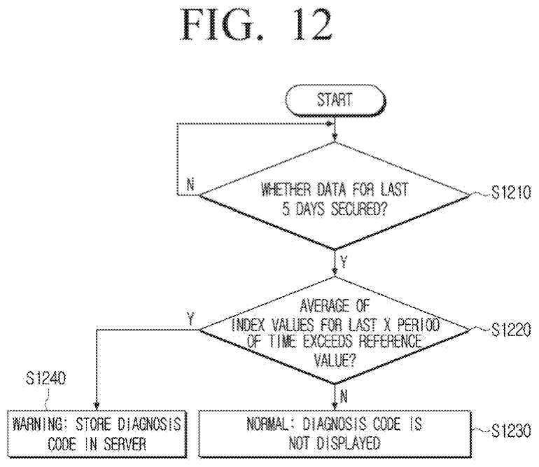

FIG. 12 is a flowchart specifically describing a diagnostic method according to at least one embodiment of the disclosure.

According to FIG. 12, the server device identifies whether state information for the refrigerator for a predetermined unit time (e.g., the last five days) has been acquired (S1210).

Based on data for the predetermined unit time or more being secured, the server device determines whether an average of index values calculated based on the secured data exceeds a reference value (S1220).

Based on determination that the average of the index values is less than or equal to the reference value, the server device may recognize the state as a normal state and may not generate or display a separate diagnosis code (S1230).

On the other hand, based on determination that the average of the index values exceeds the reference value, the server device recognizes the state as a dangerous state and generates and stores a diagnosis code therefor (S1240).

The diagnosis code stored in the server device may be displayed on a display device connected to the server device or provided to the terminal device or refrigerator of the user.

Alternatively, in the case of generating the diagnosis code, the server device may further perform an operation of generating a control signal to perform a frost or dew removal operation and transmitting the control signal to the refrigerator. Accordingly, the refrigerator may automatically perform the defrosting or dew removal operation.

As described above, according to various embodiments of the disclosure, the state and cause of frost or dew formation occurring during the use of the refrigerator may be diagnosed. In particular, because the state of frost or dew formation may be quantified and recorded, even when an A/S representative or a repair technician cannot directly check the state of the refrigerator with the naked eyes, it is possible to remotely predict the possibility of future occurrence of frost or dew formation or to remotely diagnose the current degree of occurrence.

Quantified information may be utilized in various manners. For example, when an A/S service request is received, a specific response may be made based on the quantified information, thereby enhancing customer service responsiveness. In the related art, in a case in which a refrigerator user applied for A/S due to frost or dew formation occurring under a normal situation rather than a malfunction of the refrigerator, it was difficult for a consultant to accurately identify the state or cause, ultimately resulting in the difficulty of a repair technician having to visit the site in person. However, according to the various embodiments described above, even when an inquiry is made remotely, the state of the corresponding refrigerator may be accurately identified, allowing for an explanation of the situation and a provision of solutions, thereby significantly increasing user satisfaction. In particular, the user may directly diagnose the state of the refrigerator using the refrigerator or the terminal device and even perform actions according to the diagnosis results, thereby minimizing inconvenience. As another example, the quantified information may be actively reflected in the development process of new products.

Meanwhile, the various embodiments described above may be applied to a product as an embodiment alone, but at least some of the contents may be implemented in combination with other embodiments of the disclosure.

In addition, according to an embodiment of the disclosure, the aforementioned various embodiments may be implemented as software including instructions stored in machine-readable storage media, which may be read by machines (e.g.: computers). The machines refer to devices that call instructions stored in a storage medium, and may operate according to the called instructions, and the devices may include the electronic apparatus (e.g., a server device, a refrigerator, or a terminal device) according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product.

Specifically, there may be provided a non-transitory computer-readable storage medium or a computer program product storing computer instructions for performing operations including: acquiring and storing state information of at least one refrigerator; calculating and storing an index value for frost or dew formation of a refrigerator based on the stored state information; and diagnosing the degree of frost or dew formation based on index values cumulatively stored for a predetermined period of time.

A computer program product refers to a product, and it may be traded between a seller and a buyer. A computer program product may be distributed in the form of a storage medium that is readable by machines (e.g.: a compact disc read only memory (CD-ROM)), or may be distributed on-line through an application store (e.g.: Play Store™). In the case of on-line distribution, at least a portion of a computer program product may be stored in a storage medium, such as the server of the manufacturer, the server of the application store, and the memory of the relay server at least temporarily, or may be generated temporarily.

In addition, computer instructions or programs for performing the index value calculation method or state diagnosis method according to the various embodiments described above may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment, such as a register, a cache, and a memory. As specific examples of a non-transitory computer-readable medium, there may be a CD, a DVD, a hard disc, a blue-ray disc, a USB, a memory card, a ROM and the like.

While specific example embodiments of the disclosure have been shown and described, but the disclosure is not limited to the aforementioned specific embodiments, and it is apparent that various modifications may be made by those having ordinary skill in the technical field to which the disclosure belongs, without departing from the gist of the disclosure as claimed by the appended claims. Also, it is intended that such modifications are not to be interpreted independently from the technical idea or prospect of the disclosure.

What is claimed is:

1. A server device comprising:
a communication unit configured to perform communication with at least one refrigerator;
memory storing instructions; and
at least one processor,
wherein the instructions, when executed by the at least one processor individually or collectively, cause the server device to:
receive state information of the at least one refrigerator through the communication unit and store the state information in the memory,
calculate a frost formation index value for frost formation or a dew formation index value for dew formation of each of the at least one refrigerator based on the stored state information and store the index value in the memory, and
diagnose a frost formation state or a dew formation state of the at least one refrigerator based on index values cumulatively stored during a predetermined period of time.

2. The server device as claimed in claim 1, wherein the state information comprises information regarding a number of times a defrosting operation or a dew removal operation is performed in the at least one refrigerator, external humidity information of the at least one refrigerator, and a cumulative door opening time information during which a door of the at least one refrigerator is opened for a preset unit time.

3. The server device as claimed in claim 2, wherein the instructions, when executed by the at least one processor individually or collectively, cause the server device to:
calculate the frost formation index value according to f_ indexₙ=(OH×fDAT×A)+(fNDF×B)+(f_indexₙ₋₁×C), and
calculate the dew formation index value according to r_indexₙ=(OH×rDAT×D)+(rNDF×E)+(r_indexₙ₋₁×F), and
wherein the f_ indexₙ is the frost formation index value, the OH is an external humidity value, the fDAT is a cumulative door opening time of a freezer compartment, the fNDF is the number of times the defrosting operation is performed, the f_indexₙ₋₁ is an immediately previous frost formation index value stored in the memory, the A, B, and C are preset weighting factors for diagnosing the frost formation state, the r_ indexₙ is the dew formation index value, the rDAT is a cumulative door opening time of a refrigerator compartment, the rNDF is the number of times the dew removal operation is performed, the r_ indexₙ₋₁ is an immediately previous dew formation index value stored in the memory, and the D, E, and F are preset weighting factors for diagnosing the dew formation state.

4. The server device as claimed in claim 3, wherein the instructions, when executed by the at least one processor individually or collectively, cause the server device to transmit a diagnosis code indicating an occurrence of frost formation or dew formation to a terminal device through the communication unit, based on an average value of the frost formation index values cumulatively stored for the predetermined period of time or an average value of the dew formation index values cumulatively stored for the predetermined period of time satisfying a preset condition.

5. The server device as claimed in claim 3, wherein the instructions, when executed by the at least one processor individually or collectively, cause the server device to generate a remote control signal to perform the defrosting operation or the dew removal operation and transmit the remote control signal to the at least one refrigerator through the communication unit, based on an average value of the frost formation index values cumulatively stored for the predetermined period of time or an average value of the dew formation index values cumulatively stored for the predetermined period of time satisfying a preset condition.

6. A refrigerator comprising:
a plurality of sensors;
memory storing instructions; and
at least one processor,
wherein the instructions, when executed by the at least one processor individually or collectively, cause the refrigerator to:
acquire state information of the refrigerator based on sensing values of the plurality of sensors,
calculate a frost formation index value for frost formation or a dew formation index value for dew formation of the refrigerator based on the state information,
store the index value in the memory, and
diagnose a frost formation state or a dew formation state based on index values cumulatively stored during a predetermined period of time.

7. The refrigerator as claimed in claim 6, wherein the instructions, when executed by the at least one processor individually or collectively, cause the refrigerator to:
acquire information regarding a cumulative door opening time during which a door of the refrigerator is opened for a preset unit time, based on a sensing value of a first sensor among the plurality of sensors,
acquire external humidity information of the refrigerator, based on a sensing value of a second sensor among the plurality of sensors,
perform a dew removal operation according to a sensing value of a third sensor among the plurality of sensors, and
perform a defrosting operation according to a sensing value of a fourth sensor among the plurality of sensors, and
wherein the state information comprises information regarding a number of times the defrosting operation or the dew removal operation is performed, the external humidity information, and the cumulative door opening time information.

8. The refrigerator as claimed in claim 7, wherein the instructions, when executed by the at least one processor individually or collectively, cause the refrigerator to:
calculate the frost formation index value according to f_ indexₙ=(OH×fDAT×A)+(fNDF×B)+(f_indexₙ₋₁×C), and
calculate the dew formation index value according to r_indexₙ=(OH×rDAT×D)+(rNDF×E)+(r_indexₙ₋₁×F), and
wherein the f_ indexₙ is the frost formation index value, the OH is an external humidity value, the fDAT is a cumulative door opening time of a freezer compartment, the fNDF is the number of times the defrosting operation is performed, the f_indexₙ₋₁ is an immediately previous frost formation index value stored in the memory, the A, B, and C are preset weighting factors for diagnosing the frost formation state, the r_ indexₙ is the dew formation index value, the rDAT is a cumulative door opening time of a refrigerator compartment, the rNDF is the number of times the dew removal operation is performed, the r_ indexₙ₋₁ is an immediately previous dew formation index value stored in the memory, and the D, E, and F are preset weighting factors for diagnosing the dew formation state.

9. The refrigerator as claimed in claim 8, further comprising:
a display,
wherein the instructions, when executed by the at least one processor individually or collectively, cause the refrigerator to control the display to display a diagnosis code indicating an occurrence of frost formation or dew formation, based on an average value of the frost formation index values cumulatively stored for the predetermined period of time or an average value of the dew formation index values cumulatively stored for the predetermined period of time being within a preset range.

10. The refrigerator as claimed in claim 8, wherein the instructions, when executed by the at least one processor individually or collectively, cause the refrigerator to perform the defrosting operation or the dew removal operation, based on an average value of the frost formation index values cumulatively stored for the predetermined period of time or an average value of the dew formation index values cumulatively stored for the predetermined period of time being within a preset range.

11. A method for diagnosing a state of a server device, the method comprising:
acquiring and storing state information of at least one refrigerator;
calculating and storing a frost formation index value for frost formation or a dew formation index value for dew formation in the at least one refrigerator based on the stored state information; and
diagnosing a degree of frost formation or a degree of dew formation based on index values cumulatively stored during a predetermined period of time.

12. The method as claimed in claim 11, wherein the state information comprises information regarding a number of times a defrosting operation or a dew removal operation is performed in the at least one refrigerator, external humidity information sensed by the at least one refrigerator, and cumulative door opening time information during which a door of the at least one refrigerator is opened for a preset unit time.

13. The method as claimed in claim 12, wherein the calculating and storing the frost formation index value or the dew formation index value comprises:
calculating the frost formation index value according to f_ indexₙ=(OH×fDAT×A)+(fNDF×B)+(f_indexₙ₋₁×C); and
calculating the dew formation index value according to r_indexₙ=(OH×rDAT×D)+(rNDF×E)+(r_indexₙ₋₁×F), and
wherein the f_ indexₙ is the frost formation index value, the OH is an external humidity value, the fDAT is a cumulative door opening time of a freezer compartment, the fNDF is the number of times the defrosting operation is performed, the f_indexₙ₋₁ is an immediately previous frost formation index value stored in the memory, the A, B, and C are preset weighting factors for diagnosing the degree of frost formation, the r_ indexₙ is the dew formation index value, the rDAT is a cumulative door opening time of a refrigerator compartment, the rNDF is the number of times the dew removal operation is performed, the r_ indexₙ₋₁ is an immediately previous dew formation index value stored in the memory, and the D, E, and F are preset weighting factors for diagnosing the degree of dew formation.

14. The method as claimed in claim 13, further comprising:
displaying a diagnosis code indicating an occurrence of frost formation or dew formation, based on an average value of the frost formation index values cumulatively stored for the predetermined period of time or an average value of the dew formation index values cumulatively stored for the predetermined period of time satisfying a preset condition.

15. The method as claimed in claim 13, further comprising:
generating a remote control signal to perform the defrosting operation or the dew removal operation and transmit the remote control signal to the at least one refrigerator, based on an average value of the frost formation index values cumulatively stored for the predetermined period of time or an average value of the dew formation index values cumulatively stored for the predetermined period of time satisfying a preset condition.
